(19) United States
(12) Patent Application Publication
(10) Pub. No.: US 2025/0385908 A1
(43) Pub. Date: Dec. 18, 2025

(54) DISKLESS CLIENT AUTHENTICATION SYSTEM, AUTHENTICATION SERVER, PROGRAM, AND DISKLESS CLIENT AUTHENTICATION METHOD

(71) Applicant: NTT, Inc., Tokyo (JP)

(72) Inventor: Fumihiko SAWAZAKI, Musashino-shi, Tokyo (JP)

(21) Appl. No.: 18/878,791

(22) PCT Filed: Jul. 6, 2022
(86) PCT No.: PCT/JP2022/026872

§ 371 Date: Dec. 24, 2024

(51) Int. Cl. H04L 9/40

(52) U.S. Cl. CPC H04L 63/0876

(57) ABSTRACT

A diskless client authentication system (10) includes an authentication server (100) and a filter (230) on a communication path between the diskless client (280) and a file server (200) storing a startup file. An authentication server (100) includes: an address assignment unit that assigns a network address to a diskless client (280); an authenticating unit that authenticates the diskless client (280) to which the network address has been assigned; and a client control unit that instructs the authentication unit to authenticate the diskless client (280) when the diskless client (280) to which the network address has been assigned is in an unauthenticated state, and instructs the authentication unit to permit communication between the diskless client (280) and a file server (200) when the authentication is successful.

### TECHNICAL FIELD

The present invention relates to a diskless client authentication system, an authentication server, a program, and a diskless client authentication method for performing authentication of a diskless client before system activation.

### BACKGROUND ART

A diskless client is a system that does not store an operating system (OS), an application program, user data, and the like and depends on a server (file server). The diskless client is not equipped with a hard disk drive (HDD) in which failure is likely to occur and has advantages such as being less likely to fail, being able to easily copy a system having the same configuration and being easy to set up, and having high recoverability since the system is restarted with the same configuration as that at the time of the previous startup when being reset.

The general operation at the time of startup of the diskless client is as follows (1) to (3). (1) Network configuration information (for example, an IP address, a netmask value, a gateway address, or the like) is acquired using dynamic host configuration protocol (DHCP) or the like and set. (2) A boot file is acquired from a trivial file transfer protocol (TFTP) server and executed. (3) An OS (file other than an OS loader) is acquired using a network file system (NFS) or the like, and the OS is activated,

The diskless client is a technology based on the premise that the client and the network are reliable, and authentication of the client and the server is not included in the operation at the time of startup. When a diskless client is used in an environment where client impersonation may occur, client authentication is required. As a terminal authentication method in the diskless client, three terminal authentication methods are studied in Non Patent Literature 1.

### Citation List

### Non Patent Literature

Non Patent Literature 1: Fumihiko Sawazaki, Sho Nakazawa, “Tanmatsusaido no tensoukeikinou no softwareka ni okeru diskless client gijutsu no tekiyou ni tsuite (in Japanese) (A study of application of diskless-client technology in softwareization of network functions on the terminal side)”, The Institute of Electronics, Information and Communication Engineers (IEICE) 2022 General Conference, Communication Society B-6-24, Mar. 15, 2022.

### SUMMARY OF INVENTION

### Technical Problem

Non Patent Literature 1 proposes authentication using a media access control address (MAC), authentication using a public key, and authentication using a line (for example, next generation network (NGN) standard). However, it has been pointed out that the available scenes are limited, the de facto software being utilized needs to be modified, firmware mounted on a diskless client needs to be modified, and the like. Regardless of the manufacturer, it is desirable that authentication can be performed using a widespread technology (a technology mounted as standard) mounted on a generally commercially available diskless client product.

The present invention has been made in view of such a background, and an object thereof is to enable authentication of a diskless client using a widespread technology.

### Solution to Problem

In order to solve the above problem, a diskless client authentication system according to the present invention includes an authentication server of a diskless client and a filter on a communication path between the diskless client and a file server storing a startup file of the diskless client, wherein the filter permits or prohibits communication between the diskless client and the file server according to an instruction of the authentication server, and the authentication server includes: a storage unit including a client management database that stores identification information of the diskless client and an authentication state in association with each other; an address assignment unit configured to execute a process of assigning a network address to the diskless client; an authentication unit configured to execute a process of authenticating the diskless client to which the network address has been assigned; a filter control unit configured to instruct the filter to permit or prohibit communication between the diskless client and the file server; and a client control unit configured to, when the diskless client to which the network address has been assigned is in an unauthenticated state with reference to the client management database, instruct the authentication unit to execute the process of authenticating the diskless client, and instruct the filter control unit to permit communication between the diskless client and the file server when the process of authenticating is successful.

### Advantageous Effects of Invention

According to the present invention, authentication of a diskless client using a widespread technology can be enabled.

### BRIEF DESCRIPTION OF DRAWINGS

FIG. 1 is a diagram for describing an overall configuration of a diskless client authentication system according to the present embodiment.

FIG. 2 is a functional block diagram of an authentication server according to the present embodiment.

FIG. 3 is a data configuration diagram of a client management database according to the present embodiment.

FIG. 4 is a sequence diagram of an authentication processing according to the present embodiment.

FIG. 5 is a sequence diagram of end processing according to the present embodiment.

FIG. 6 is a hardware configuration diagram illustrating an example of a computer that realizes a function of the authentication server according to the present embodiment.

### DESCRIPTION OF EMBODIMENTS

### Outline of Diskless Client Authentication System

Hereinafter, a diskless client authentication system in a mode (embodiment) for carrying out the present invention will be described. The diskless client authentication system includes an authentication server and a filter, The filter is provided between the diskless client and a file server (storage) that stores a boot file and an OS file, and performs filtering of communication data. The filter is, for example, a router (edge router), and performs filtering of an IP datagram on the basis of a MAC address, a network address, and a protocol. The filter basically prohibits communication between the diskless client and the file server. However, if there is an instruction of permission from the authentication server, the filter permits communication between the diskless client and the file server until there is an instruction of prohibition.

The authentication server authenticates the diskless client using a standard hardware-based management authentication function after assigning the IP address to the diskless client using the DHCP. When the authentication succeeds, the authentication server instructs the filter to allow communication between the diskless client and the file server, to instruct the diskless client to restart. The restarted diskless client can communicate with the file server, and starts the OS according to a normal procedure. If the authentication fails, communication between the diskless client and the file server remains prohibited, and the diskless client cannot startup the OS.

According to such a diskless client authentication system, only an authenticated diskless client can start (OS) using a diskless client equipped with a widespread technology or an existing file server. It is not necessary to modify the diskless client or the file server, and the diskless client system can be easily introduced.

### Overall Configuration of Diskless Client Authentication System

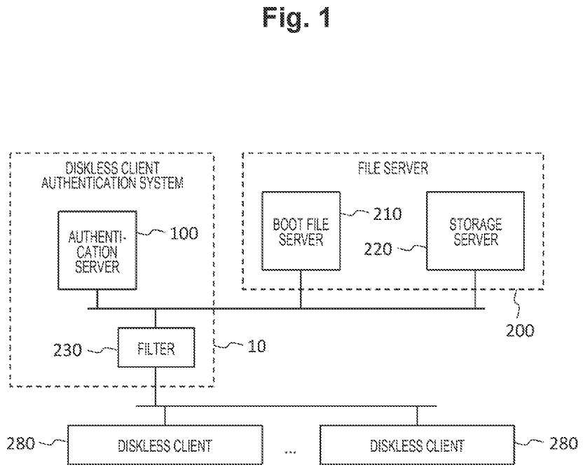

FIG. 1 is a diagram for describing an overall configuration of a diskless client authentication system 10 according to the present embodiment. The diskless client authentication system 10 includes an authentication server 100 and a filter 230. The diskless client authentication system 10 may further include a boot file server 210 and a storage server 220.

The boot file server 210 is, for example, a TFTP server, and transmits a boot file (for example, a boot image of preboot execution environment (PXE)) in response to a request from the diskless client 280. The storage server 220 is, for example, an NFS server, and exchanges an OS, an application program, and user data in response to a request from the diskless client 280. Hereinafter, the boot file server 210 and the storage server 220 will be collectively referred to as a file server 200.

The filter 230 is installed between a network to which the diskless client 280 is connected and a network to which the file server 200 is connected, and performs filtering of communication data. The filter 230 performs filtering based on, for example, a physical address, a network address (IP address), and a protocol (for example, a port number).

The filter 230 permits communication for setting network information and communication for authentication including a network address exchanged between the diskless client 280 and the authentication server 100. However, the filter 230 basically prohibits (filters) communication between the diskless client 280 and the file server 200. When there is an instruction of permission from the authentication server 100, the filter 230 permits communication between the instructed diskless client 280 and the file server 200. Communication between the other diskless client 280 and the file server 200 remains prohibited. When there is an instruction of prohibition from the authentication server 100, the filter 230 prohibits communication between the instructed diskless client 280 and the file server 200.

### Configuration of Authentication Server

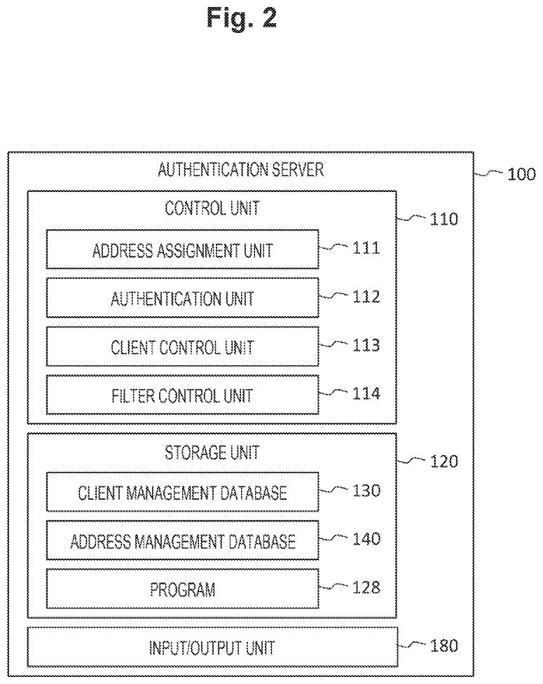

FIG. 2 is a functional block diagram of the authentication server 100 according to the present embodiment. The authentication server 100 is a computer, and includes a control unit 110, a storage unit 120, and an input/output unit 180. A user interface device such as a display, a keyboard, and a mouse is connected to the input/output unit 180. The input/output unit 180 includes a communication device, and can transmit and receive data to and from the filter 230 and the diskless client 280. In addition, a media drive may be connected to the input/output unit 180 so that data can be exchanged using a recording medium.

### Storage Unit

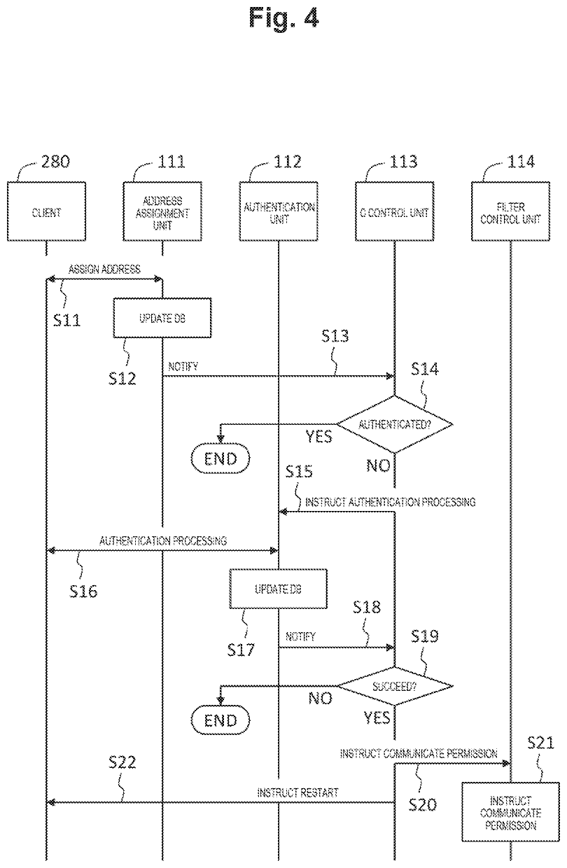

The storage unit 120 includes a storage device such as a read only memory (ROM), a random access memory (RAM), or a solid state drive (SSD). The storage unit 120 stores a client management database 130, an address management database 140, and a program 128. The program 128 includes a description of a processing procedure of the authentication server 100 in an authentication processing to be described below (see FIG. 4 to be described below).

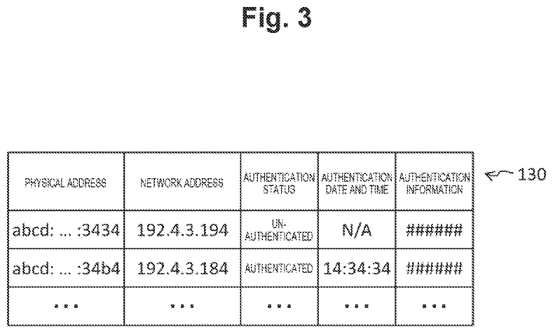

FIG. 3 is a data configuration diagram of the client management database 130 according to the present embodiment. The client management database 130 is, for example, data in a table format, and a row (record) of table indicates a state of the diskless client 280. The record includes a physical address, a network address, an authentication status, an authentication date and time, and a column (attribute) of authentication information.

The physical address indicates a physical address of the diskless client 280, and is, for example, an Ethernet address. The physical address is referred to as identification information of the diskless client 280. The network address indicates a network address assigned to the diskless client 280, and is, for example, an assigned IP address.

The authentication state indicates whether the diskless client 280 has succeeded in authentication (authenticated/unauthenticated (including before authentication and authentication failure)). The authentication date and time indicates the date and time when the diskless client 280 is last authenticated (only the time is described in FIG. 3).

The authentication information indicates information to be referred to when authenticating the diskless client 280, and is, for example, a public key or confidential information (password) shared with the diskless client 280. The authentication information is preset (registered) together with the physical address.

The client management database 130 may include other information (attributes). For example, the client management database 130 may include a date and time when authentication is successful, a date and time when a network address is assigned, and the like,

Returning to FIG. 1, the description of the storage unit 120 will be continued. The address management database 140 stores a network address assigned to the diskless client 280. Each network address is associated with whether or not it has been assigned, an assignment expiration, a physical address of the assigned diskless client 280, a physical address of the last assigned diskless client 280, and the like.

### Control Unit

The control unit 110 includes a central processing unit (CPU), and includes an address assignment unit 111, an authentication unit 112, a client control unit 113, and a filter control unit 114,

The address assignment unit 111 assigns a network address to the diskless client 280. In addition, the address assignment unit 111 notifies the diskless client 280 of setting information of various networks (for example, a default gateway and a network address of the boot file server 210). The address assignment unit 111 performs assignment and notification using DHCP, for example.

The authentication unit 112 authenticates the diskless client 280. The diskless client 280 at the start of authentication is in a state before the OS boots although the network address has been assigned. The authentication unit 112 performs authentication using an authentication function of hardware-based management of the diskless client 280. Examples of hardware-based management include Intel active management technology (AMT) and AMD PRO, The authentication unit 112 authenticates the diskless client 280 using an authentication function mounted as standard in hardware of the diskless client 280.

The client control unit 113 instructs the diskless client 280 to perform an authentication processing, a restart, or the like and controls the authentication processing, the restart, or the like.

The filter control unit 114 instructs the filter 230 to filter communication between the diskless client 280 and the file server 200. For example, the filter control unit 114 notifies the filter of the physical address and the network address of the diskless client 280 and instructs the filter to permit communication between the diskless client 280 and the file server 200. When receiving the instruction, the filter 230 refers to a physical address, a network address, a port number (protocol identification information), and the like, and permits passage of communication data exchanged between the diskless client 280 and the file server 200.

### Authentication Processing

FIG. 4 is a sequence diagram of the authentication processing according to the present embodiment. Processing from the startup (power-on) of the diskless client 280 to the startup of the OS will be described with reference to FIG. 4. In FIG. 4, the diskless client 280 is referred to as a “client”, and the client control unit 113 is referred to as a “C control unit”.

In step S11, the diskless client 280 and the address assignment unit 111 perform a network address assignment processing using, for example, DHCP. In addition to the network address assignment, the address of the default gateway or the boot file server 210 is notified.

When the authentication state of the record of the diskless client 280 specified by the physical address is “authenticated” in the client management database 130 (see FIG. 3), the address assignment unit 111 assigns the network address in the network address of the record.

In a case where there is no record of the diskless client 280 in the client management database 130 (in the case of unregistered), the address assignment unit 111 notifies the diskless client 280 of an error and does not assign an address. When the authentication state of the record is “unauthenticated”, the address assignment unit 111 assigns an unassigned network address with reference to the address management database 140. The reason for this processing will be described below.

In step S12, the address assignment unit 111 updates the client management database 130. More specifically, when an unassigned network address is assigned in step S11, the address assignment unit 111 updates the network address of the record of the diskless client 280 specified by the physical address to the network address assigned in step S11. Note that the authentication state of the record is “unauthenticated”.

When the authentication state of the client management database 130 is “authenticated” and the network address in the network address of the record is assigned, the address assignment unit 111 does not update the client management database 130.

In step S13, the address assignment unit 111 notifies the client control unit 113 of the physical address of the diskless client 280 to which the address has been assigned.

In step S14, the client control unit 113 refers to the client management database 130, and the diskless client 280 notified in step S13 acquires the authentication state. The client control unit 113 ends the authentication processing when the authentication has been completed (step S14—YES), and proceeds to step S15 when the authentication has not been completed (step S14—NO). The operation of the diskless client 280 after the authentication processing of the authentication server 100 is completed will be described below.

In step S15, the client control unit 113 instructs the authentication unit 112 to execute authentication processing of the diskless client 280.

In step S16, the diskless client 280 and the authentication unit 112 execute an authentication processing.

In step S17, the authentication unit 112 updates the client management database 130. More specifically, the authentication unit 112 updates the authentication state to “authenticated” or “unauthenticated” according to the success or failure of the authentication.

In step S18, the authentication unit 112 notifies the client control unit 113 of the result of the authentication processing (see step S16).

In step S19, the client control unit 113 proceeds to step S20 if the authentication succeeds (step S19→YES), and ends the authentication processing if the authentication fails (step S19→NO).

In step S20, the client control unit 113 notifies the physical address and the network address of the diskless client 280, and instructs the filter control unit 114 to permit communication between the diskless client 280 and the file server 200.

In step S21, the filter control unit 114 notifies the physical address and the network address of the diskless client 280, and instructs the filter 230 to permit communication between the diskless client 280 and the file server 200.

In step S22, the client control unit 113 instructs the diskless client 280 to restart. The diskless client 280 that has received the restart instruction restarts and returns to step S11. At this point, since the diskless client 280 and the file server 200 can communicate with each other, normal startup processing can be performed. That is, the restarted diskless client 280 acquires network information other than a network address (see step S11), acquires and executes a boot file from the boot file server 210, and acquires and executes files other than an OS loader from the storage server 220, thereby starting up the OS. The assigned network address is the same as the previous one (network address acquired in unauthenticated state, see step S11) because it is in the authenticated state.

### End Processing

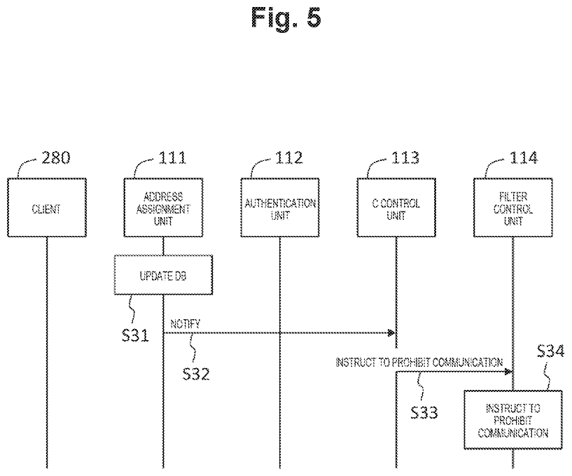

FIG. 5 is a sequence diagram of end processing according to the present embodiment. With reference to FIG. 5, processing such as a case where an address release notification from the diskless client 280 is received, a case where an assignment of a network address is expired, and a case where a disconnection instruction of the diskless client 280 is received from an administrator will be described.

In step S31, the address assignment unit 111 updates the client management database 130 (see FIG. 3). More specifically, the address assignment unit 111 sets the network address corresponding to the diskless client 280 to “N/A”, sets the authentication state to “unauthenticated”, and sets the authentication date and time to “N/A”. Note that “N/A” is an abbreviation of “Not Applicable” meaning not applicable, invalid, or the like. In addition, the address assignment unit 111 updates the network address assigned to the diskless client 280 in the address management database 140 to an unassigned state.

In step S32, the address assignment unit 111 notifies the physical address of the diskless client 280 to the client control unit 113.

In step S33, the client control unit 113 notifies the physical address of the diskless client 280 and instructs the filter control unit 114 to prohibit communication between the diskless client 280 and the file server 200.

In step S34, the filter control unit 114 notifies the physical address of the diskless client 280 and instructs the filter 230 to prohibit (filter) communication between the diskless client 280 and the file server 200.

### Features of Diskless Client Authentication System

When the diskless client 280 is connected to the network or startup, the authentication server 100 assigns a network address (see step S11), performs authentication (see step S16), and the authentication is successful (see step S19→YES), the communication with the file server 200 is permitted (see step S21), In a case where the authentication does not succeed, for example, in a case where the client management database 130 is not registered, the diskless client 280 cannot communicate with the file server 200 and cannot start the OS. The authentication processing is performed by a function of hardware-based management, which is a widespread technology, and can be used by many diskless clients distributed on the market. In addition, it is not necessary for the user of the diskless client 280 to intervene, and there is no difference from conventional usability.

### Modified Example: Restart Instruction

The authentication server 100 of the above-described embodiment instructs the diskless client 280 to restart (see step S22) after the authentication processing succeeds (see step S16). If the diskless client 280 attempts to access the boot file server 210 during the authentication processing, the restart instruction may be omitted.

For example, if the authentication processing ends during the time of the product of the packet timeout time of TFTP and the number of times of packet retransmission, the restart instruction may be omitted. From the time when the communication is permitted (see step S21), the diskless client 280 can access the boot file server 210, and can continue normal startup processing including network address acquisition (see step S11).

### Modification Example

Although some embodiments of the present invention have been described above, these embodiments are merely examples and do not limit the technical scope of the present invention. For example, the authentication server 100 includes the address assignment unit 111 and assigns a network address to the diskless client 280, but the address assignment unit 111 may be separated as a network address assignment server (DHCP server). However, an assigned network address is assigned to the authenticated diskless client 280.

In the embodiment described above, the address assignment unit 111 updates the authentication state of the diskless client 280 in the client management database 130 (see FIG. 3) to “unauthenticated” (see step S31 described in FIG. 5). Alternatively, the client control unit 113 may update after receiving the notification (see step S32).

The present invention can take various other embodiments, and various modifications such as omissions and substitutions can be made without departing from the gist of the present invention. These embodiments and modifications thereof are included in the scope and gist of the invention described in the present specification and the like, and are included in the invention described in the claims and the equivalent scope thereof.

### Hardware Configuration

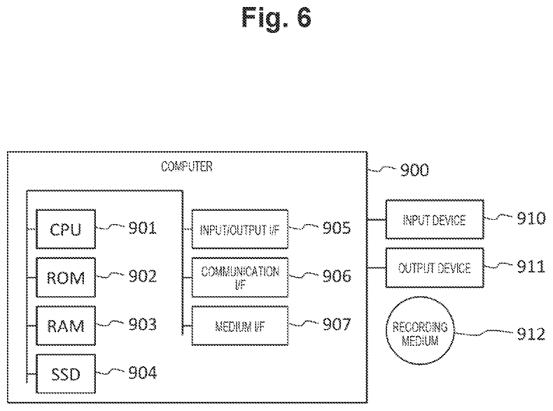

The authentication server 100 according to the above-described embodiment is realized by, for example, a computer 900 having a configuration as illustrated in FIG. 6. FIG. 6 is a hardware configuration diagram illustrating an example of the computer 900 that implements functions of the authentication server 100 according to the present embodiment. The computer 900 includes a CPU 901, a ROM 902, a RAM 903, an SSD 904, an input/output interface 905 (described as an input/output interface (I/F) in FIG. 6), a communication interface 906 (described as a communication I/F in FIG. 6), and a medium interface 907 (described as a medium I/F in FIG. 6). The computer 900 may include a hard disc drive (HDD) instead of the SSD 904 and may further include an HDD in addition to the SSD 904.

The CPU 901 operates on the basis of a program stored in the ROM 902 or the SSD 904, and performs control by the control unit 110 in FIG. 2. The ROM 902 stores a boot program executed by the CPU 901 when the computer 900 is activated, a program related to hardware of the computer 900, and the like.

The CPU 901 controls an input device 910 such as a mouse and a keyboard and an output device 911 such as a display and a printer via the input/output interface 905. The CPU 901 acquires data from the input device 910 and outputs generated data to the output device 911 via the input/output interface 905.

The SSD 904 stores a program to be executed by the CPU 901, data to be used by the program, and the like. The communication interface 906 receives data from another device (for example, the filter 230 or the diskless client 280) not illustrated via a communication network and outputs the data to the CPU 901, and transmits data generated by the CPU 901 to the another device via the communication network.

The medium interface 907 reads a program or data stored in a recording medium 912 and outputs the program or data to the CPU 901 via the RAM 903. The CPU 901 loads the program from the recording medium 912 into the RAM 903 via the medium interface 907, and executes the loaded program. The recording medium 912 is an optical recording medium such as a digital versatile disk (DVD), a magneto-optical recording medium such as a magneto optical disk (MO), a magnetic recording medium, a conductor memory tape medium, a semiconductor memory, or the like.

For example, when the computer 900 functions as the authentication server 100 according to the present embodiment, the CPU 901 of the computer 900 achieves the function of the authentication server 100 by executing the program 128 (see FIG. 2) loaded on the RAM 903. The CPU 901 reads the program from the recording medium 912 and executes the program. In addition, the CPU 901 may read the program from another device via the communication network, or may install the program 128 from the recording medium 912 to the SSD 904 and execute the program 128.

### Effects

Hereinafter, effects of the diskless client authentication system 10 will be described,

The diskless client authentication system 10 according to the above-described embodiment includes the authentication server 100 of the diskless client 280 and the filter 230 on the communication path between the diskless client 280 and the file server 200 storing the startup file (boot file or OS file) of the diskless client 280.

The filter 230 permits or prohibits communication between the diskless client 280 and the file server 200 according to an instruction of the authentication server 100.

The authentication server 100 includes the storage unit 120 including the client management database 130 that stores identification information (physical address) of the diskless client 280 and an authentication state in association with each other,

The authentication server 100 includes an address assignment unit 111 that executes processing of assigning a network address to the diskless client 280.

The authentication server 100 includes the authentication unit 112 that executes a process of authenticating the diskless client 280 to which the network address has been assigned.

The authentication server 100 includes the filter control unit 114 that instructs the filter 230 to permit or prohibit the communication between the diskless client 280 and the file server 200.

The authentication server 100 includes the client control unit 113 that instructs the authentication unit to execute a process of authenticating the diskless client by referring to the client management database 130 when the diskless client 280 to which the network address has been assigned is in an unauthenticated state, and instructs the filter control unit 114 to permit communication between the diskless client 280 and the file server 200 when the authentication processing is successful.

According to such a diskless client authentication system 10, the diskless client 280 that has succeeded in authentication can access the file server 200 and (OS/system) is activated successfully. The diskless client 280 that has failed in authentication cannot access the file server 200 and cannot be activated. The authentication can be performed by a function of hardware-based management, which is a widespread technology, and is available in many diskless clients distributed on the market.

When instructing the filter control unit 114 to permit communication between the diskless client 280 and the file server 200, the client control unit 113 according to the above-described embodiment instructs the diskless client 280 to restart

According to such a diskless client authentication system 10, even in a case where the startup processing after the authentication processing in the diskless client 280 is interrupted, the file server 200 can be accessed and activated after the network address is acquired again by restarting.

The client control unit 113 according to the above-described embodiment instructs the filter control unit 114 to prohibit the communication between the diskless client 280 and the file server 200 and sets the authentication state of the diskless client 280 as unauthenticated in any of a case of receiving a notification of release of the assigned network address from the diskless client 280, a case of reaching an assignment expiration of the network address, and a case of receiving a disconnection instruction of the diskless client 280 (for example, from an administrator).

According to such a diskless client authentication system 10, the diskless client 280 that has released the network address, has passed the expiration date of the network address, or has been designated by the administrator cannot access the file server 200. In addition, a restart cannot be performed without authentication.

The filter 230 permits or prohibits passage of communication data exchanged between the diskless client 280 and the file server 200 based on at least one of a physical address, a network address, and protocol identification information (for example, a port number) of the diskless client 280 and the file server 200.

According to such a diskless client authentication system 10, a standard router or switch can be used as the filter 230.

### Reference Signs List

10 Diskless client authentication system

100 Authentication server

111 Address assignment unit

112 Authentication unit

113 Client control unit

114 Filter control unit

130 Client management database

200 File server

230 Filter

280 Diskless client

1. A diskless client authentication system configured to include an authentication server of a diskless client and a filter on a communication path between the diskless client and a file server storing a startup file of the diskless client, wherein
the filter permits or prohibits communication between the diskless client and the file server according to an instruction of the authentication server, and
the authentication server includes:
a storage unit including a client management database that stores identification information of the diskless client and an authentication state in association with each other;
an address assignment unit, including one or more processors, configured to execute a process of assigning a network address to the diskless client;
an authentication unit, including one or more processors, configured to execute a process of authenticating the diskless client to which the network address has been assigned;
a filter control unit, including one or more processors, configured to instruct the filter to permit or prohibit communication between the diskless client and the file server; and
a client control unit, including one or more processors, configured to:
instruct, when the diskless client to which the network address has been assigned is in an unauthenticated state with reference to the client management database, the authentication unit to execute the process of authenticating the diskless client, and
instruct the filter control unit to permit communication between the diskless client and the file server when the process of authenticating is successful.

2. The diskless client authentication system according to claim 1, wherein
when instructing the filter control unit to permit communication between the diskless client and the file server, the client control unit is configured to instruct the diskless client to restart.

3. The diskless client authentication system according to claim 1, wherein
in any of a case of receiving a notification of release of an assigned network address from the diskless client,
a case of reaching an assignment expiration of the network address, and
a case of receiving a disconnection instruction from the diskless client,
the client control unit is configured to instruct the filter control unit to prohibit communication between the diskless client and the file server, and set an authentication state of the diskless client as unauthenticated.

4. The diskless client authentication system according to claim 1, wherein
the filter is configured to permit or prohibit passage of communication data exchanged between the diskless client and the file server based on at least one of a physical address, a network address, and protocol identification information of the diskless client and the file server.

5. An authentication server that is on a communication path between a diskless client and a file server that stores a startup file of the diskless client, is communicatively connected to a filter that permits or prohibits communication between the diskless client and the file server, and authenticates the diskless client, the authentication server comprising:
a storage unit including a client management database that stores identification information of the diskless client and an authentication state in association with each other;
an address assignment unit, including one or more processors, configured to execute a process of assigning a network address to the diskless client;
an authentication unit, including one or more processors, configured to execute a process of authenticating the diskless client to which the network address has been assigned;
a filter control unit, including one or more processors, configured to instruct the filter to permit or prohibit communication between the diskless client and the file server; and
a client control unit, including one or more processors, configured to:
when the diskless client to which the network address has been assigned is in an unauthenticated state with reference to the client management database, instruct the authentication unit to execute the process of authenticating the diskless client, and
instruct the filter control unit to permit communication between the diskless client and the file server when the process of authenticating is successful.

6. A program for causing a computer to function as the authentication server according to claim 5.

7. A diskless client authentication method of an authentication server that is on a communication path between a diskless client and a file server that stores a startup file of the diskless client, is communicatively connected to a filter that permits or prohibits communication between the diskless client and the file server, and authenticates the diskless client,
wherein the authentication server includes
a storage unit including a client management database that stores identification information of the diskless client and an authentication state in association with each other, and the diskless client authentication method comprises:
executing a process of assigning a network address to the diskless client;
authenticating a diskless client to which a network address has been assigned when the diskless client is in an unauthenticated state with reference to the client management database; and
instructing the filter to permit communication between the diskless client and the file server when the authentication of the diskless client is successful.
